(19) United States
(12) Patent Application Publication
(10) Pub. No.: US 2012/0282824 A1
(43) Pub. Date: Nov. 8, 2012

(54) CONTACT ELEMENT, ASSEMBLY AND METHOD FOR ESTABLISHING CONTACT WITH AN ELECTRICAL COMPONENT, ESPECIALLY AN ELECTROCHEMICAL ENERGY STORE

(75) Inventors: Tim Schaefer, Harztor (DE); Andreas Gutsch, Leudinghausen (DE); Claus-Rupert Hohenthanner, Hanau (DE); Joerg Kaiser, Eggenstein (DE)

(73) Assignee: Li-Tec Battery GmbH, Kamenz (DE)

(21) Appl. No.: 13/504,502

(22) PCT Filed: Oct. 20, 2010
(86) PCT No.: PCT/EP2010/006425

§ 371 Date: Jul. 20, 2012

(30) Foreign Application Priority Data
Oct. 29, 2009 (DE) 10 2009 051 217.9

(51) Int. Cl. H01R 13/02; H01R 43/16

(52) U.S. Cl. 439/884; 29/874

(57) ABSTRACT

The invention relates to contacting elements (910) for contacting one or more electrical components, such as e.g. electrochemical energy stores (901, 902), said contacting elements comprising first flat prismatic recesses for receiving the connecting elements of one or more electrical components, especially the conducting leads (903, 904, 905, 906, 907, 908) of one or more electrochemical energy stores, and second flat prismatic recesses for receiving electrical conductors (912, 913, 914, 915). The contacting elements have bores at a right angle to the first and second flat prismatic recesses, said bores receiving fastening means (909, 911).

The invention relates to a contact element, to an assembly, and to a method for establishing contact with an electrical component, especially an electrochemical energy store. The term ‘establishing contact’ shall be understood to mean the electrical connection of the electrical terminals of an electrical component to the environment thereof.

Numerous solutions for establishing contact with electrical components, and especially with electrochemical energy stores, are known from the prior art. However, these known solutions are associated with specific disadvantages.

It is therefore the object of the present invention to provide a technical teaching for the most effective and cost-efficient contact establishment possible with electrical components, and especially with electrochemical energy stores.

This object is achieved by a product and a method according to any one of the independent claims. The dependent claims protect several advantageous refinements of the present invention.

According to the invention, a contact element that is designed as a dimensionally stable body is provided for an electrical component, and especially for an electrochemical energy store, wherein this body comprises at least one substantially flat prismatic first depression for accommodating a connecting element of the electrical component, especially of a collector of the electrochemical energy store, and at least one first borehole that is substantially perpendicular to this first depression.

According to the invention, moreover an assembly for establishing contact with an electrical component, especially an electrochemical energy store, comprising at least one contact element is provided, in which an electrical conductor is located in at least one second depression of at least one contact element, the electrical conductor being connected to a switch element.

According to the invention, moreover a method for establishing contact with an electrical component, especially an electrochemical energy store, is provided, in which at least one connecting element of this electrical component, and especially at least one collector of an electrochemical energy store, is accommodated by at least one first depression of a contact element.

According to the invention, moreover a method for producing an assembly for establishing contact with an electrical component, especially an electrochemical energy store, is provided, in which at least one connecting element of this electrical component, and especially at least one collector of an electrochemical energy store, is accommodated by at least one first depression of a contact element.

Finally, according to the invention an electrical component, especially an electrochemical energy store or an assembly for establishing contact with an electrical component, is provided, with which contact has been established or which have been produced according to such a method.

Terms will be used in the context of the description of the invention which are explained hereafter.

An electrical component shall be understood to mean any device which is suitable for creating an electrical circuit by the connection to other or similar electrical components, such as to an electrical energy load, an electrical energy source, an electrical, and more particularly electrochemical, energy store, or additional electrical components.

An electrochemical energy store shall be understood to mean any device which is able to convert energy stored in chemical form into electrical energy and to provide this energy in electrical form for an application. Important examples of such electrochemical energy stores include galvanic cells or batteries comprising several galvanic cells or also what are known as fuel cells. Several of these electrochemical energy stores are rechargeable, which is to say that electrical energy supplied to these stores can be stored in chemical form.

Important examples of rechargeable electrochemical energy stores include rechargeable galvanic cells, which are also referred to as secondary cells.

A contact element for an electrical component, especially for an electrochemical energy store, shall be understood to mean any product which is suitable to create an electrical connection between at least one terminal of an electrical component and the application environment thereof, or to support the creation of this connection. The application environment of an electrical component usually includes conductor structures, electrical energy loads, sources of electrical energy or other electrical components.

A dimensionally stable body, especially of a contact element, shall be understood to mean a physical object which substantially maintains the physical or spatial shape thereof under the customary usage conditions of electrical components, especially of electrochemical energy stores. Examples of dimensionally stable bodies include bodies made of solid metallic materials or made of solid plastic materials.

A connecting element of an electrical component shall be understood to mean a structural element of an electrical component which allows the electrical connection of the electrical component to the environment thereof. Examples of connecting elements of an electrical component include the collectors of an electrochemical energy store.

A collector of an electrochemical energy store shall be understood to mean a structural element of an electrochemical energy store which electrically connects the electrodes of one polarity in the interior of the electrochemical energy store and leads this electrical connection from the interior of the electrochemical energy store to the outside, so that objects outside the electrochemical energy store can electrically interact with the interior of the electrochemical energy store.

Such collectors are frequently implemented as electrically conductive, and frequently as flat, metallic metal sheets. Because an electrochemical energy store usually comprises electrodes having two different polarities, an electrochemical energy store typically comprises at least two collectors.

A substantially flat prismatic depression for accommodating a connecting element, especially for accommodating a collector, shall be understood to mean a structure in the body of a contact element which is designed so as to accommodate at least partially a connecting element of an electrical component, especially a collector of an electrochemical energy store. Such depressions are removed in the form of cavities from the body of the contact element. In terms of the possible geometric shapes of these depressions, it is typical that they have two parallel interfaces, which are frequently larger than all the remaining interfaces of the depression. Examples of such depressions include cavities in which the large parallel surfaces have the shape of a rectangle, trapezoid, semi-circle or triangle.

A borehole in a body of a contact element, the borehole extending substantially perpendicularly to such a depression, shall be understood to mean a borehole in which the axis is substantially perpendicular to the large surfaces of the flat prismatic depression.

A switch element shall be understood to mean an electrical, electronic, electromechanical or optoelectronic or similar component, which can be used to switch an electrical current. Switching an electrical current shall be understood to mean activating or deactivating or varying the current intensity of an electrical current.

A contact element according to the invention, or the body of such a contact element, preferably comprises at least one substantially flat prismatic second depression for accommodating an electrical conductor and at least one second borehole that is substantially perpendicular to this second depression. The axis of this second borehole does not need to be oriented parallel to the axis of the first borehole, and instead can be located at any arbitrary angle with respect to the axis of the first borehole.

The body of a contact element according to the invention is preferably electrically conductive. According to other embodiments of the invention, contact elements have bodies which are made only partially of electrically conductive materials and partially of electrically insulating materials. Such embodiments of the invention are advantageous in particular when a contact element, in addition to establishing the electrical contact, is supposed to implement other design functions, such as the mechanical integration of a component with which contact is to be established in the environment thereof, and if at least partial electrical insulation of a connecting element with respect to the environment thereof is to occur, for example so as to prevent short circuits.

A preferred assembly according to the invention comprises a switch element in an electrically insulating housing. According to other embodiments of the invention, a housing for the switch element is at least partially electrically conductive and in this case is preferably used to establish contact with one contact or with several contacts of the switch element.

According to a preferred assembly according to the invention, the or a switch element is arranged in a housing which is positively connected to the body of at least one contact element comprising in the second depression thereof an electrical conductor which is connected to this switch element.

In a further preferred assembly according to the invention, the or a switch element comprises at least one semiconductor component. Preferred examples of such semiconductor components form what are known as metal oxide semiconductor field effect transistors (MOSFETs).

In a further preferred assembly according to the invention, the or a switch element comprises at least one electromechanical component.

In a further preferred assembly according to the invention, fastening means are guided through at least one first and/or second borehole, the means preferably comprising a stud bolt.

In a preferred method according to the invention, fastening means are guided through at least one first and/or second borehole, the means comprising a stud bolt which, when tightened, brings about a non-positive connection between an electrical conductor, especially a collector of an electrochemical energy store, and a body of a contact element.

Additional preferred embodiments, which cannot be exhaustively or completely described here, result from a combination of features of the aforementioned preferred embodiments.

The invention will be described in more detail hereafter based on preferred embodiments and with the help of figures. In the figures:

FIG. 1 is a schematic top view of an electrochemical energy store for use in connection with various exemplary embodiments of the present invention;

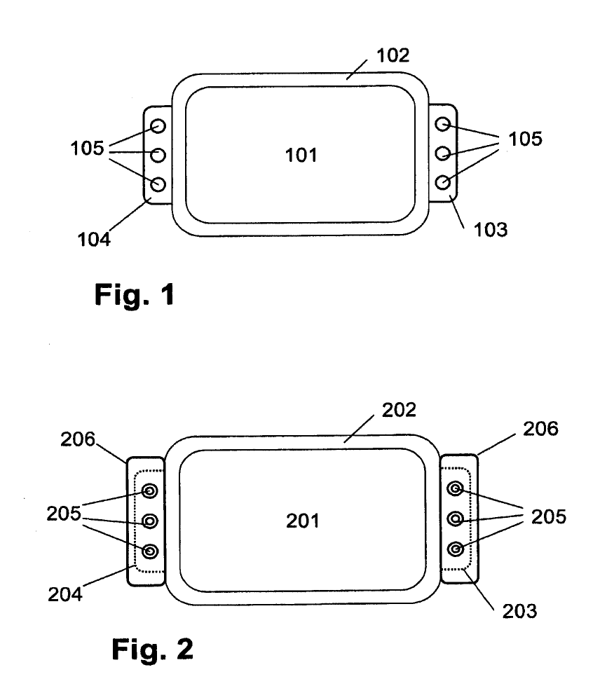

FIG. 2 is the electrochemical energy store shown in FIG. 1 comprising contact elements at the collectors according to a preferred embodiment of the invention;

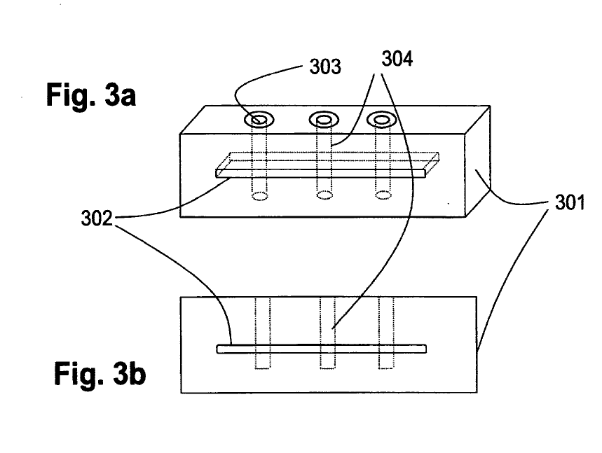

FIG. 3 shows schematic illustrations of two views (FIG. 3a, FIG. 3b) of a contact element according to a preferred embodiment of the invention;

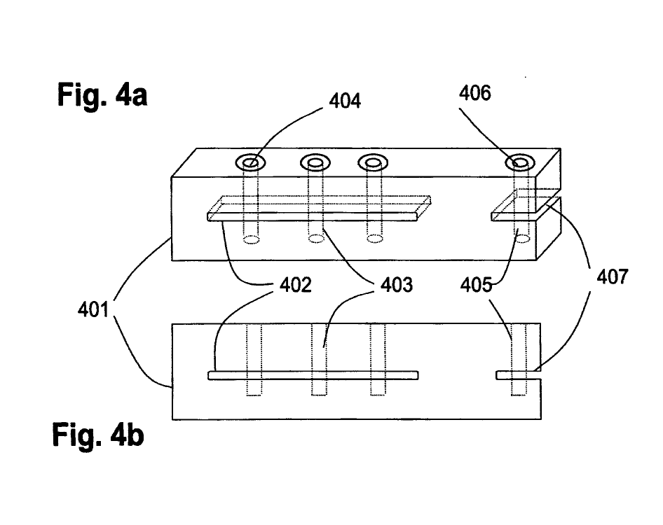

FIG. 4 shows schematic illustrations of two views (FIG. 4a, FIG. 4b) of a contact element according to a preferred embodiment of the invention;

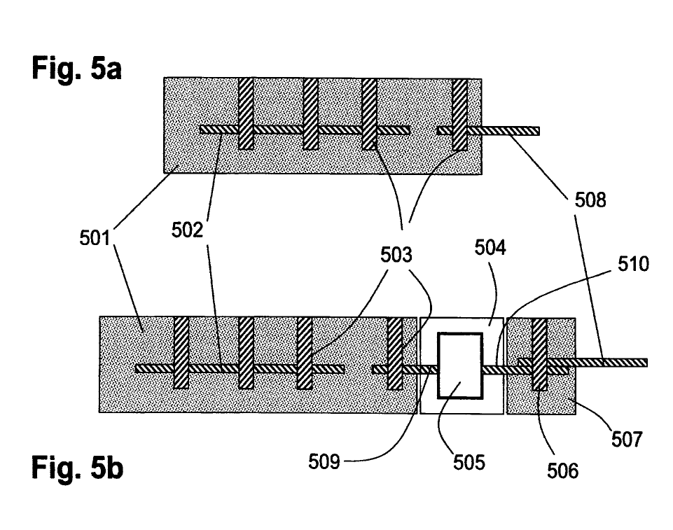

FIG. 5 shows schematic illustrations of views (FIG. 5a, FIG. 5b) of two contact elements according to two preferred embodiments of the invention;

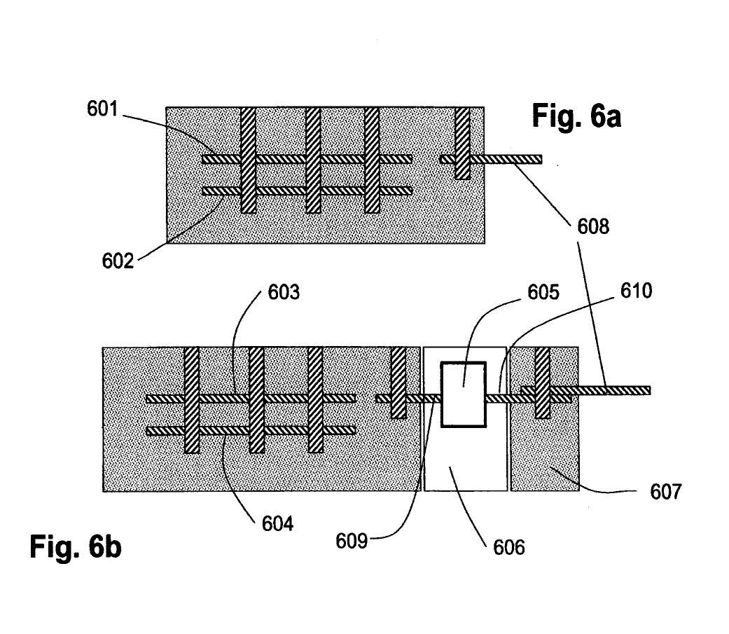

FIG. 6 shows schematic illustrations of views (FIG. 6a, FIG. 6b) of two contact elements according to two preferred embodiments of the invention;

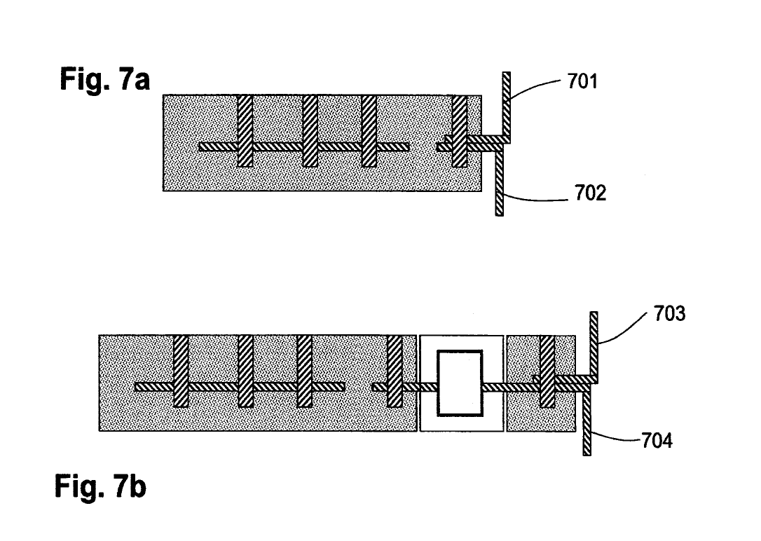

FIG. 7 shows schematic illustrations of views (FIG. 7a, FIG. 7b) of two contact elements according to two preferred embodiments of the invention;

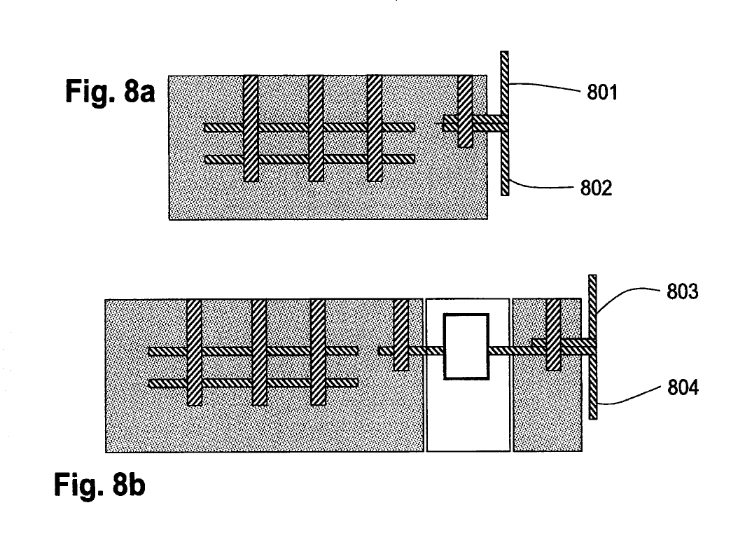

FIG. 8 shows schematic illustrations of views (FIG. 8a, FIG. 8b) of two contact elements according to two preferred embodiments of the invention;

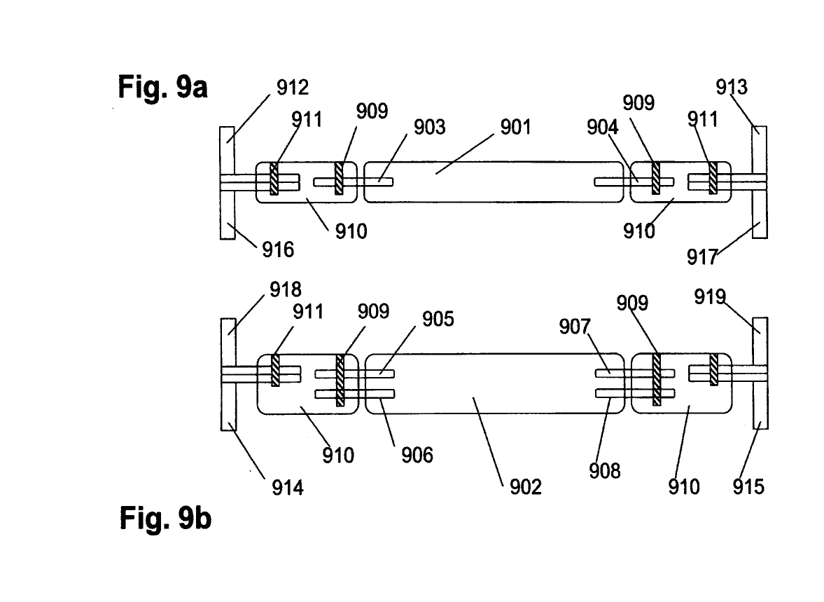

FIG. 9 shows schematic illustrations of two embodiments (FIG. 9a, FIG. 9b) of assemblies according to the invention;

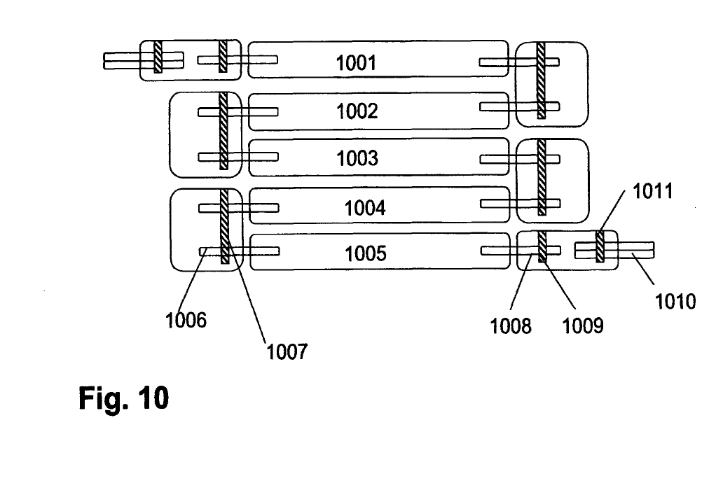

FIG. 10 is a schematic illustration of an embodiment of an assembly according to the invention;

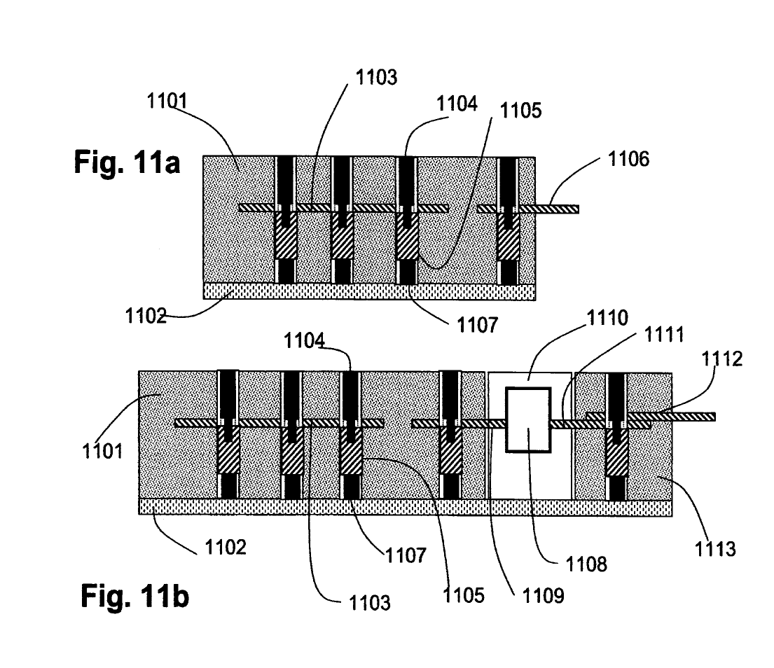

FIG. 11 shows schematic illustrations of two embodiments (FIG. 11a, FIG. 11b) of assemblies according to the invention; and

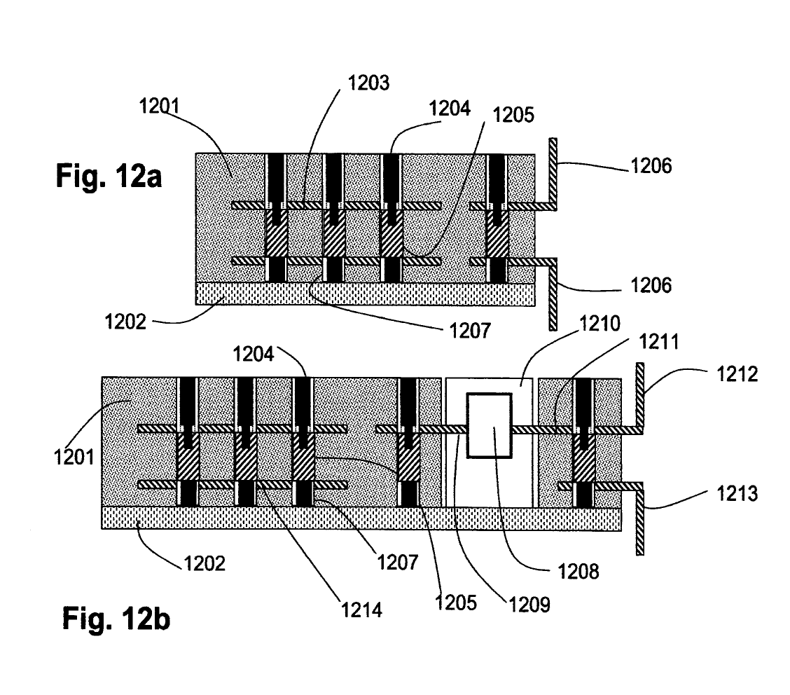

FIG. 12 shows schematic illustrations of two embodiments (FIG. 12a, FIG. 12b) of assemblies according to the invention.

The exemplary embodiment of an electrical component shown schematically in FIG. 1, for example an electrochemical energy store, is one as that which can be used in the context of the present invention. The illustration shows a storage cell 101, which can be a single galvanic cell or a fuel cell or a similar electrochemical energy storage unit, for example, comprising a packaging or a housing 102 from which the electrical connecting elements protrude, which in the case of an electrochemical energy store are the collectors 103, 104 thereof, which are provided with boreholes 105.

The connecting elements or collectors are preferably flat metallic, or in any case electrically conductive, metal sheets which protrude from the housing 102 and which are electrically connected to the electrodes of the respective polarity, for example in the interior of the storage unit 101. The metal collector sheets are used to establish contact between the electrochemical energy storage unit and the application environment thereof, which is usually electrical conductors, which are in turn connected to current loads or current generators. So as to support this contact establishing, the collectors are preferably provided with boreholes 105, through which fastening means can be guided.

FIG. 2 shows an equivalent electrochemical energy store 201, at the collectors 203, 204 of which contact elements 206 are provided, which are fastened by way of fastening means 205. The fastening means used can preferably be screws. By attaching the contact elements 206 to the housing 202 of the electrochemical energy store 201 preferably by way of a positive connection, it can be assured that bending of the collectors 203, 204 due to forces acting perpendicularly to the plane of the drawing are counteracted. This is particularly advantageous to counteract damage to the electrochemical energy store, which can frequently be caused by bending of the metal collector metals.

The contact elements 206 shown in FIG. 2 are used, amongst others, to promote the current transfer from the collectors to the application environment. In many cases, they are also used to improve the heat transfer from the frequently easily heat conducting collectors to the application environment or to a heat sink in the application environment. In addition, the contact elements can also be used for mechanical integration, which is to say the installation of an electrical component in the environment thereof.

The primary function of the contact element, however, is to improve or create an electrical contact between the connecting elements of an electrical component, this being in particular the collectors of the electrochemical energy store, and the application environment. This is usually achieved by way of a low-impedance, preferably large-surface-area, connection between the electrical conductors of the application environment and the contact elements.

As is shown schematically in FIG. 3, the contact elements 301 according to the invention have dimensionally stable bodies, which are provided with at least one depression 302. FIG. 3a is a perspective view of this contact element. FIG. 3b shows a side view of the same contact element. This depression is used to accommodate the collectors in the body of the contact element. The depression is therefore designed substantially as a flat prismatic cavity, whereby the connecting elements 203, 204, or the collectors 203, 204, which are preferably likewise designed as substantially flat prismatic metal sheets, can be easily inserted in this depression. So as to improve the establishment of the electrical contact, according to the invention at least one borehole 304 is provided, the axis of which is substantially perpendicular to the flat prismatic depression. Fastening means 303, preferably a screw or the like, are introduced in this first borehole 304, whereby the electrical connection, and preferably also the heat transfer connection, between the collectors and the bodies of the contact elements can be improved due to positive and non-positive connection when the fastening elements are tightened.

FIG. 4 shows another preferred exemplary embodiment of a contact element according to the invention, the body 401 of which, in addition to the at least one substantially flat prismatic first depression 402 comprising the boreholes 403 which are preferably perpendicular thereto, comprises at least one substantially flat prismatic second depression 407 for accommodating an electrical conductor, aside from this first depression 402. Perpendicular to this second depression, the body has a second borehole 405, the axis of which is substantially perpendicular to the main surface of this second depression. Fastening means 406, preferably a screw, can be introduced in this borehole 405, whereby a particularly close electrical connection, and preferably easily heat conducting connection, can be created between an electrical conductor of the application environment to be introduced in this second depression 407 and the contact element by way of positive and non-positive connection. FIG. 4a is a perspective view of this contact element. FIG. 4b shows a side view of the same contact element.

In total, the contact element according to the invention thus allows a particularly good electrically conducting connection, and preferably also a particularly easily heat conducting connection, to be created between the connecting elements of an electrical component, especially the collectors of an electrochemical energy store, on the one hand and the conductors of the application environment on the other hand, whereby particularly good current conduction and particularly efficient heat conduction can be achieved. This is essentially assured by the simultaneous positive and non-positive connection of the contact element both to the collector and to the external electrical conductor of the application environment.

In all the exemplary embodiments shown within the scope of this description, the body of the contact element is preferably made of an electrically conductive material and preferably also of an easily heat conducting material. For this purpose, preferably metallic materials are considered. These have not only sufficient electrical conductivity and high conductivity, but usually also stand out because of the high dimensional stability thereof. According to other embodiments of the invention, contact elements are produced only partially from electrically conductive materials. This can result in advantages, for example, when a contact element is supposed to create an electrically conducting connection to a conductor of the application environment, yet the contact element is also supposed to serve to insulate the electrical energy store with respect to the housing structures or structures of installed technology. In these cases, in which the body of the contact element is not entirely made of an electrically conductive material, the respective environment of the first and second depressions will be made of an electrically conductive material so as to assure current transfer and—if so desired—efficient heat transfer, of possible, between the collector or collectors of the electrochemical energy store and the conductors of the application environment to be connected.

In some application cases, it is desirable to design the electrical connection between a connecting element 502 of an electrical component, which is to say, for example, a collector 502 of an electrochemical energy store, and the application environment thereof so that this connection can be disconnected. In these cases, the invention provides for embodiments such as those shown in FIG. 5b, which are characterized by a switch element 505, the terminals 509, 510 of which are electrically connected to the contact element 501 on the one side and the application environment on the other. The connection to the application environment is preferably created via a contact element 507 which has a depression or depressions accommodating a terminal 510 of the switch element and connecting the same to a conductor 508 of the application environment in an electrically conducting manner. This is preferably achieved with the aid of a borehole 506 and a fastening means introduced in this borehole. This assembly corresponds to the assembly 503, 508 of FIG. 5a in terms of the application environment.

Such switch elements are frequently advantageously arranged in an insulating housing 504, which is preferably positively connected to the body 501 of at least one contact element 501, 507, in the depression of which an electrical conductor 509, 510 is located, which is connected to this switch element 505. This preferred embodiment of the invention is associated with the advantage that the electrical connection between the contact element and the switch element on the one hand, and the electrical connection between the switch element and the application environment 507 on the other hand, is protected against bending and the attendant destruction which can be caused by forces acting perpendicularly to the connecting axis of the aforementioned elements.

FIG. 6 shows schematic illustrations of two embodiments (FIG. 6a, FIG. 6b) of the invention, which largely correspond to the embodiments shown in FIG. 5 (FIG. 5a, FIG. 5b), wherein the embodiments shown in FIG. 6 (FIG. 6a, FIG. 6b) show contact elements, the bodies of which comprise two first flat prismatic depressions 601, 602, 603, 604. These first depressions 601, 602, 603, 604 are used to accommodate two connecting elements of one or two electrical components which are to be connected in an electrically conducting manner and are used to establish contact therewith in an electrically conducting manner. Via the body of the contact element which is produced at least partially from an electrically conductive material, these connecting elements are connected to an electrical conductor 608 of an environment or they are connected to a first terminal 609 of a switch element 605, which is preferably accommodated in an electrically insulating housing 606 and the second terminal 610 of which is preferably connected via a contact element 607 to an electrical conductor 608 of an environment.

The exemplary embodiments shown in FIG. 7 (FIG. 7a, FIG. 7b) differ from the exemplary embodiments shown in FIG. 5 (FIG. 5a, FIG. 5b) by the connection of the contact element, or of the switch element, to two electrical conductors 701, 702, 703, 704 of the electrical application environment. Similarly, the exemplary embodiments shown in FIG. 8 (FIG. 8a, FIG. 8b) differ from the exemplary embodiments shown in FIG. 6 (FIG. 6a, FIG. 6b) by the presence of two electrical conductors 801, 802, 803, 804 of the electrical connection environment. These and similar embodiments of the invention are preferably to be used in situations in which the manner of interconnection of several electrical components, for example in a parallel connection, requires an electrical connection of the connecting elements to two or more electrical conductors of the application environment, or makes such a connection expedient.

FIG. 9 shows schematic illustrations of two embodiments of assemblies according to the invention, in which respective electrical components, for example electrochemical energy stores 901, 902, are in contact with two (FIG. 9a) or four (FIG. 9b) connecting elements, for example collectors 903, 904, 905, 906, 907, 908 with the aid of contact elements 910 which connect the corresponding connecting elements, for example collectors of the electrochemical energy stores, with the aid of fastening elements 909, 911 to electrical conductors 912, 913, 914, 915, 916, 917, 918, 919 of the application environment, preferably by way of positive and non-positive connection.

FIG. 10 shows another embodiment of an assembly according to the invention, in which a plurality of electrochemical energy stores 1001, 1002, 1003, 1004, 1005 are connected with the aid of contact elements according to the invention having differing embodiments in accordance with the invention to depressions 1006, 1008 and boreholes 1007, 1009 and 1011 to form a series connection, which are connected to the application environment by way of electrical conductors 1010.

FIG. 11 shows two further embodiments (FIG. 11a, FIG. 11b) of the invention, in which the preferably electrically conductive bodies 1101 of the contact elements are provided on one side with preferably electrically insulating plastic panels 1102. Boreholes 1107, through which fastening means 1104, 1105, which preferably comprise stud bolts 1104, can be guided, run preferably perpendicularly to the first and second depressions, into which connecting elements 1103 or other electrical conductors 1106 can be inserted.

One of these embodiments (FIG. 11b) comprises a switch element 1108, which is preferably accommodated in an electrically insulating housing 1110 and the terminals 1109, 1111 of which can be inserted in the depressions of the neighboring contact elements. The plastic panel can be used for the mechanical stabilization of the contact element or of an assembly comprising contact elements and a switch element. It can also be used for the electrical insulation with respect to parts of the application environment which are not to have the same potential as the connecting elements with which this assembly establishes contact.

The stud bolts 1104 preferably provided as fastening means allow particularly easy installation and with respect to establishing the best possible electrical contact, they also allow very effective installation of the contact elements according to the invention or corresponding assemblies. For this purpose, a corresponding contact element is placed on a connecting element of an electrical component with which contact is to be established. Subsequently, for example, an Allen key can be guided through a borehole and the stud bolt can be tightened until the desired contact force is reached.

FIG. 12 shows two further embodiments (FIG. 12a, FIG. 12b) of the invention, in which the preferably electrically conductive bodies 1201 of the contact elements are provided on one side with preferably electrically insulating plastic panels 1202. Boreholes 1207, through which fastening means 1204, 1205, which preferably comprise stud bolts 1204, can be guided, run preferably perpendicularly to the first and second depressions, into which connecting elements 1203, 1204 or other electrical conductors 1206 can be inserted. Contrary to FIG. 11, two depressions 1203, 1204 are provided here to simultaneously establish contact with two connecting elements of one or two electrical components.

One of these embodiments (FIG. 12b) comprises a switch element 1208, which is preferably accommodated in an electrically insulating housing 1210 and the terminals 1209, 1211 of which can be inserted in the depressions of the neighboring contact elements.

The plastic panel can be used for the mechanical stabilization of the contact element or of an assembly comprising contact elements and a switch element. It can also be used for the electrical insulation with respect to parts of the application environment which are not to have the same potential as the connecting elements with which this assembly establishes contact.

The stud bolts 1204 preferably provided as fastening means allow particularly easy installation and with respect to establishing the best possible electrical contact, they also allow very effective installation of the contact elements according to the invention or corresponding assemblies. With a corresponding design, the stud bolt can be tightened clockwise or counterclockwise until the desired contact force for establishing the electrical contact with the upper or lower contacting element is achieved. For this purpose, the stud bolts are advantageously alternately tightened clockwise and counterclockwise during installation.

In all corresponding embodiments of the invention, the switch element is preferably implemented as a semiconductor component or as an electromechanical component. A metal oxide semiconductor field effect transistor (MOSFET) is particularly preferred, the source or drain terminals of which are preferably connected to the contact element on the one hand and to the electrical application environment on the other hand. A MOSFET is an active semiconductor component. It operates like a voltage-controlled resistor. For this purpose, it has three terminals: the gate and two electrodes referred to as drain and source. In some types, an additional terminal (bulk, substrate) is conducted to the outside. However, in most instances the bulk is connected internally to the source. When using MOSFETs that have a separate bulk terminal, smaller AC voltages can be controlled and switched between the source and drain when the substrate terminal—in the case of n-channel MOSFETs—is kept more negative than the AC voltage.

For use in the context of the present invention, in particular what are known as power MOSFETs are suitable. A power MOSFET is a specialized version of a metal oxide semiconductor field effect transistor (MOSFET) which is optimized for conducting and blocking large electrical currents and voltages, for current intensities up to several hundred amperes and voltages up to approximately 1,000 volts.

Power MOSFETs differ from bipolar power transistors both in the operating principle and in the efficiency. Several advantages of power MOSFETs include the fast switching time, no second breakdown, and stable amplification and response times. Starting at a current-carrying capacity of approximately 1 ampere, a MOSFET becomes a power MOSFET. These properties allow power MOSFETS to seem particularly suitable for use in the context of various exemplary embodiments of the invention.

In other embodiments of the invention, it is also possible to use combination circuits comprising two or more semiconductor components or electromechanical components as the switch element, provided that, for example, the deactivation of an individual electrochemical energy store in a battery of such energy stores and the transmission to the next adjoining electrochemical energy store are desired.

When using electrically controllable switch elements, such as electromechanical switches or semiconductor component switches, for example, it is preferred for the electrical control to be carried out as a function of a temperature measured at or in the electrochemical energy stores with the aid of a sensor, whereby the activation and deactivation of individual electrochemical energy stores can be carried out as a function of the temperatures thereof.

1. A contact element for an electrochemical energy store, designed as a dimensionally stable body, comprising:
at least one substantially flat prismatic first depression to accommodate a collector of the electrochemical energy store; and
at least one first borehole that is substantially perpendicular to the first depression,
wherein the dimensionally stable body comprises at least one substantially flat prismatic second depression to accommodate an electrical conductor and at least one second borehole that is substantially perpendicular to the second depression.

2. The contact element according to claim 1, wherein the dimensionally stable body comprises an electrically conductive region and at least one electrically insulating region.

3. The contact element according to claim 1, wherein the dimensionally stable body is electrically conductive.

4. An assembly for establishing contact with an electrical component comprising at least one contact element according claim 1, wherein
an electrical conductor is located in at least one second depression of at least one contact element, the electrical conductor being connected to a switch element.

5. The assembly according to claim 4, wherein the switch element is arranged in an electrically insulating housing.

6. The assembly according to claim 4, wherein the switch element is arranged in a housing which is positively connected to the body of at least one contact element, the at least one contact element comprising in a second depression thereof an electrical conductor, which is connected to the switch element.

7. The assembly according to claim 4, wherein the switch element comprises at least one semiconductor component.

8. The assembly according to claim 4, wherein the switch element comprises at least one electromechanical component.

9. The assembly according to claim 4, wherein fasteners are guided through at least one first borehole, the fastener comprising a stud bolt.

10. A method for producing a contact element according to claim 1, comprising:
milling at least one first and/or second depression.

11. A method for establishing contact with an electrical component or for producing an assembly according to claim 1, comprising:
accommodating at least one connecting element of the electrical component in at least one first depression of a contact element.

12. The method according to claim 11 for producing an assembly according to claim 9, wherein
the fastener is guided through at least one first and/or second borehole, the fastener comprising a stud bolt which, when tightened, causes a non-positive connection between an electrical conductor and a body of a contact element.

13. An electrical component with which contact is established in a method according to claim 10.

14. An assembly for establishing contact with an electrical component produced in a method according to claim 10.

15. The assembly according to claim 4, wherein the electrical component includes an electrochemical energy store.

16. The method according to claim 11, wherein the electrical component includes an electrochemical energy store, and the connecting element is a collector of the electrochemical energy store.

17. The method according to claim 12, wherein the electrical conductor is a collector of an electrochemical energy store.
